(19) United States
(12) Patent Application Publication
(10) Pub. No.: US 2005/0104524 A1
(43) Pub. Date: May 19, 2005

(54) Universal lamp illumination system

(76) Inventor: James G. Bishop, Strongsville, OH (US)

Correspondence Address: Christopher J. Whewell;Western Patent Group, 6020 Tonkowa Trail, Georgetown, TX, 78628, US

(21) Appl. No.: 10/985,189

(22) Filed: Nov. 10, 2004

Related U.S. Application Data
(60) Provisional application No. 60/519,955, filed on Nov. 17, 2003.

(51) Int. Cl. H05B 41/00

(52) U.S. Cl. 315/56; 315/312; 315/60

(57) ABSTRACT

Adapters for retrofitting lamps which were originally designed to function with conventional incandescent light bulbs with arc-discharge lamps are provided. Use of an adapter according to the invention provides a system by which a lamp may employ an arc discharge lamp for illuminative purposes, which lamp does not receive its electrical energy through the threads of the socket on the lamp, as in conventional incandescent lighting, but rather receives its energy from a source external to the lamp. The original wiring which came with the lamp may be eliminated by use of a system according to the present invention.

### CROSS-REFERENCE TO RELATED APPLICATIONS

This application claims the benefit of U.S. Provisional Application Ser. No. 60/519,955, filed Nov. 17, 2003, which application is incorporated herein by reference in its entirety.

### TECHNICAL FIELD

The present invention relates generally to the field of electric illumination. More particularly it relates to means for retrofitting existing lamp fixtures to render them useful with fluorescent lamps.

### BACKGROUND INFORMATION

Since the earliest of modem times, it has been recognized as desirable to provide a cost-effective means for producing useful, practical illumination from electrical energy. Most inhabitants of modem countries are familiar with various lighting means including incandescent lamps and arc discharge or fluorescent lighting. It is to the art of arc discharge lamps to which the present invention is concerned, to the extent that it is desirable to provide a cost-effective means for retrofitting existing electrical devices which employ incandescent lamps to the use of fluorescent lamps. However, the principles of the present invention are also applicable to incandescent and other forms of electrically-stimulated means for illumination.

The art of arc discharge lamps took a quantum leap with the successful demonstration of the usefulness of these lamps by Charles F. Brush in his March 1880 demonstration in the town of Wabash, Ind. Mr. Brush's lamps comprised carbon electrodes sealed in a chamber in vacuo along with a prescribed quantity of elemental sodium. The electrons of monatomic sodium vapor contained in the envelope absorb energy and undergo a transition, emitting photons visible as the yellow light frequently observed by passers-by along various highways today. Arc-discharge lamps are generally more desirable than their incandescent counterparts since they produce a relatively large amount of lumens per energy input and dissipate a lessened amount of energy in the form of heat as compared with incandescent lamps. However, the discharge lamps typically require an increased amount of associated hardware relative to incandescent lamps. Accordingly, arc-discharge lamps have only found use where the energy savings can offset the costs of the additional hardwares required. Nevertheless, ever since the initial efforts of Mr. Brush, it has been an ongoing goal of pioneers in the lighting industries to devise such contrivances as may have been believed to render arc-lighting more economically affordable to a larger number of consumers, for various reasons.

Accordingly, the prior art is replete with examples of developments related to reaping the advantages associated with arc lighting. Many of these developments are concerned with the retrofit or use of existing electrical systems which were originally designed for use with incandescent lamps to arc discharge lamp uses. For example, U.S. Pat. No. 5,634,820 describes an adapter module which allows the use of a low-wattage, compact fluorescent lamp in an ordinary light socket. The lamp has a built-in ballast, and the unit as a whole is discarded upon lamp failure; U.S. Pat. No. 5,596,247 describes a fluorescent lamp which is designed to screw into an existing light socket; U.S. Pat. No. 5,135,407 describes a conversion kit which enables the user of a portable work light to substitute a fluorescent lamp in the place of an incandescent lamp; U.S. Pat. No. 5,073,845 describes a retrofit socket useful with fluorescent light fixtures; U.S. Pat. No. 4,936,789 teaches an assembly through which an incandescent lamp may be powered from a standard incandescent lamp socket; and U.S. Pat. No. 4,723,200 teaches a holder for an electric light, all of which, including patents cited as references therein are herein incorporated by reference. However, each of the teachings of the prior art are not without one or more inherent disadvantages rendering them unsuitable for providing en masse adoption of the use of fluorescent lamps in various capacities formerly reserved for incandescent lighting.

Generally speaking, compact arc-discharge lamps or compact fluorescent lamps (CFL's) have power ratings in the range of about 5-50 watts and vary in size accordingly. These fluorescent lamps are not directly interchangeable with the incandescent lamps they are intended to replace owing to the different operating requirements of each. One of the extra items required in an arc lighting system a ballast, which consists essentially of a coil of wire of many turns and which functions to limit the flow of current through the lamp which, in the absence of the ballast would otherwise be practically limitless, thus destroying the fluorescent tube in short order. Therefore, fluorescent lamps have specially designed bases which ensure that they are not inserted into lamp sockets intended for the incandescent. Built-in ballasts are common in fluorescent lamps for wattages up to about 20 W. However, such systems are uneconomical in that when the CFL lamp eventually fails the unit as a whole, including the ballast, must be discarded. For the fluorescent lamps available which contain internal ballasts, the ability to include the ballast in the lamps is limited by the wattage of the lamp. For example, it is not practicable to provide internal ballasts on lamps having wattages greater than about 20 W. Through use of the instant invention, there is no limit to the wattage of the lamp retrofitted. Additionally, it is not necessary to discard the ballast when the lamp fails, as is required by the prior art lamps which contain an internal ballast; hence use of the instant invention saves end user costs and manufacturing resources. Furthermore, in general terms, the systems presently available possess the drawbacks that: 1) the increase in lamp wattages desired for a particular use are accompanied by a attendant increase in the size of the ballast required; and 2) many of the newer lamps are incompatible with 110-120 VAC house current and therefore require that special fixtures or lamp/ballast assemblies must be used.

In consideration of the problems above, it would be desirable to have at hand a device or system which provides a means for permitting existing fixtures comprising incandescent lamps to be readily refitted with fluorescent lamps. It is also desirable to provide a means for providing the possibility of the use of a wide range of ballasts in such systems, including those ballasts with normal power factors, high power factors, magnetic, and electronic types. It would also be desirable to provide such a system which is useful with either two-pin type or four-pin type fluorescent lamps. Since higher wattage arc discharge lamps require larger and more complicated ballasts which will not fit existing fixtures, it would also be desirable to have at hand a means for permitting existing incandescent lamp retrofits for use with fluorescent lamps which permit the easy and convenient interchange of different ballasts, external from the adapter or fixture with coordinated connectors for different lamp types. It would also be desirable that such a device comprise a ballast which is remote with respect to the remaining elements of the device. It would also be desirable for such a system to not require the discard of the ballast along with lamp replacement as is common in the present state of this art. Additionally, it is desirable to provide the possibility of the use of a remote dimming ballast to enable the user to control the intensity of the light emitted by the fluorescent lamp.

Also, owing to the inherent design of the circuitry of the instant invention, it is not possible for a fluorescent lamp to operate in the situation where there is no ballast connected to the adapter. This is of particular advantage in disallowing an unintentional blowout as is readily possible with the devices of the prior art.

The versatility of the instant invention becomes evident when one considers the fact that with low wattage compact fluorescent lamps having their ballast built in, inexpensive electronics are used. However, with the two-pin compact fluorescent lamps a magnetic ballast must be used because the high voltage kick putout by the glo-bottle starter built into the lamp would destroy the electronics. These lamps will operate on common house current (120 VAC). The compact fluorescent lamps having wattages in the range of about 26-42 W will not operate with 120 VAC because the arc tube voltage is greater than 120V and the lamp would not remain illuminated. A higher lamp voltage must be supplied by the ballast which is the reason why these ballasts are larger, more expensive, and normally separate from the lamp. Also, such higher wattage lamps are of the 4-pin design. By keeping the ballast separate from the lamp it is possible to install any type ballast and control circuit desired. In the teachings of the prior art, none contains any provision for readily changing the ballast to suit the intended application as provided herein. Through use of this invention it is possible to convert to any arc-discharge lamp instead of an incandescent lamp by merely selecting the proper ballast and inserting the desired arc-lamp socket into the adapter herein. Finally, any household floor or table lamp can be adapted to use fluorescent lamps in accordance with the teachings herein. While the prior art has attempted to permit the same, the devices therein taught are much too large or cumbersome to be used in such applications, since the prior art devices are not suited to fit within existing lamp-shade support harps. Through use of the teachings of the instant invention, it is possible to easily convert any existing lamp socket to a 42 watt compact fluorescent lamp, which emits roughly an equivalent lumen output as emitted by a 250 W incandescent lamp.

### SUMMARY OF THE INVENTION

Through use of the devices of this invention, the retrofitting of a wide variety of fluorescent lamps to existing incandescent lamp sockets is now possible for the first time, at a greatly reduced cost and a greatly increased degree of user-friendliness.

The present invention provides an adapter useful for retrofitting lamps designed for incandescent light bulbs, with an arc discharge lamp, which adapter comprises: a) a base portion having a side wall, an upper surface, and a lower surface, which upper surface is adapted to receive an arc discharge lamp, and wherein the base portion includes a plurality of sockets which are adapted to receive the pins of an arc discharge lamp when such lamp is inserted into the base portion; b) a threaded tip portion attached to the lower surface of the base portion which threaded tip portion has an outer surface which is contoured to screw into a conventional lamp socket; and c) means for conveying electrical energy to the plurality of sockets. According to one form of the invention, the outer surface of the threaded tip portion is not in effective electrical contact with any of the plurality of sockets. The outer surface of the threaded tip portion is not essential for conveying electrical energy to any of the sockets, as its function is only structural inasmuch as it is used to enable the adapter of the invention to be screwed into an existing lamp socket. Energy for illuminating a lamp in an adapter according to the invention does not depend on the standard light bulb socket as part of its means for conveying electrical energy to the conducting gas within the fluorescent envelope, as such is accomplished by means of a plurality of conductors, as further described herein.

The invention also provides a system for providing illumination which comprises: a) a conventional lamp that is designed to receive conventional incandescent lamps screwed into an on-board socket; b) an adapter comprising: i) a base portion having a side wall, an upper surface, and a lower surface, which upper surface is adapted to receive an arc discharge lamp, and wherein the base portion includes a plurality of sockets which are adapted to receive the pins of an arc discharge lamp when such lamp is inserted into the base portion; ii) a threaded tip portion attached to the lower surface of the base portion which threaded tip portion has an outer surface which is contoured to screw into a conventional lamp socket; and iii) a means for conveying electrical energy to the plurality of sockets, screwed in the on-board socket; c) an arc-discharge lamp affixed to the adapter; and d) a source of electrical energy in effective electrical contact with the means for providing electrical energy to the plurality of sockets.

### BRIEF DESCRIPTION OF THE DRAWINGS

FIG. 1 is an exploded schematic of a system according to the present invention;

FIG. 2 is a perspective view of a socket useful in a system of the invention; and

FIG. 3 is a perspective view of an alternate embodiment of a socket useful in a system of the invention;

### DETAILED DESCRIPTION

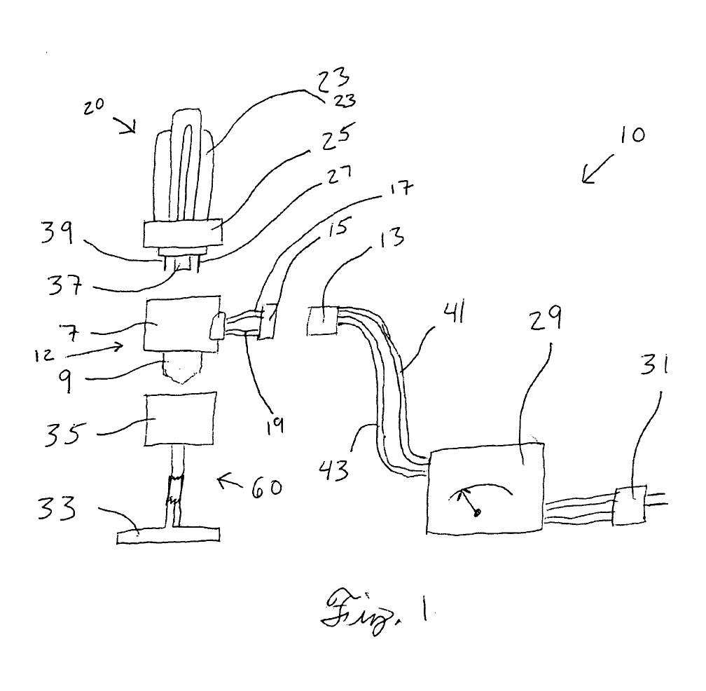

Referring to the drawings and initially to FIG. 1 there is shown an exploded schematic diagram of a system according to the present invention. In FIG. 1 there is shown an existing lamp 60, which comprises a base portion 33 and a socket portion 35 in this embodiment. However, the present invention is not limited to lamps having base portions; hence this embodiment shall not be construed as being delimitive of the metes and bounds of the invention. The socket portion 35 is a conventional light bulb socket, as is well-known in the art, into which may be screwed an ordinary light bulb.

There is an adapter 12 according to the invention, which comprises a threaded tip portion 9 which is adapted to be screwed into the socket portion 35 in the same fashion as a light bulb would be screwed in. The threaded tip portion 9, however, is different than the threaded portions on the light bulbs of the prior art, in that it may be comprised of a non-conducting material, since the purpose of the threaded tip portion 9 has nothing to do with conduction of electricity into the lamp which is illuminated. In fact, the threaded portion may be comprised of a non-conductor such as wood, plastic, glass, etc., since its surface does not comprise a portion of the electrical circuit which powers the lamp 20. Rather, energy to power the lamp is supplied to the lamp by means of conductors 17 and 19, convenient connection from a controlled electrical source thereto being made in a preferred form of the invention by a connector 15.

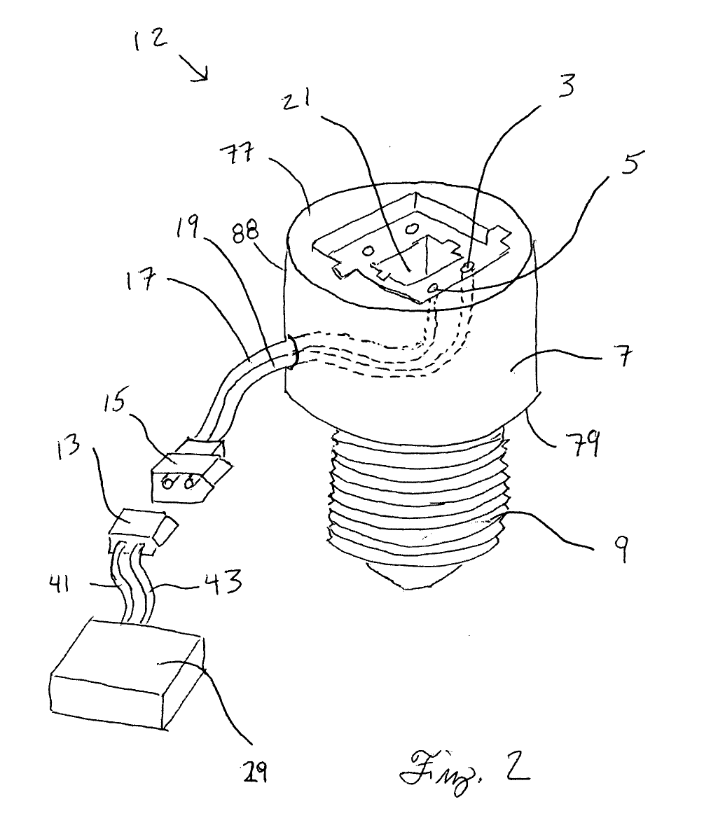

The adapter 12 also includes a base portion which is adapted to receive a compact fluorescent lamp 20. The typical fluorescent lamp 20 is shown in FIG. 1 as comprising contact pins 27 and 39 which serve as the points of contact for the source of electrical energy which is used to power the lamp 20, as is known in the art. The lamp 20 also includes a base portion 25 and a tube portion 23, within which is contained the fluorescing gas, and a locator 37 which assists in correct positioning of the lamp within the adapter as shown in FIG. 2.

Power to the lamp is supplied by a combined rheostat and ballast 29, which is connected to a conventional 110 VAC power supply by means of the plug 31. Power is conducted to the adapter 12 by means of conductors 41 and 43 and conveniently connected by means of connector 13 which cooperatively connects with 15 such that the conductors (wires) 41 and 43 are each in effective electrical contact with one of conductors 17 and 19. The rheostat may be used to dim the lamp when in use, as is known to those skilled in the art and as described in my U.S. Pat. No. 6,124,673, the entire contents of which are herein incorporated by reference thereto.

FIG. 2 shows a perspective view of an adapter 12 useful in a system of the invention, having a threaded tip portion 9 and a base portion 7. The base portion comprises a side wall 88, an upper surface 77 and a lower surface 79. The upper surface 77 of the base portion is provided with a cutout which substantially matches the contour of the base portion of the lamp 20 which is to be used, such as inclusion of a locator slot 21 into which the locator 37 on the lamp may be inserted to provide a rigid fit, as is known in the art. As the lamp 20 is pressed into its location in the base portion 7 of the adapter 12, the contact pins 27 and 39 enter into socket recesses 3 and 5 in the base portion 7, in such manner that the contact pins 27 and 39 are caused to each be in effective electrical contact with conductors 19 and 17, respectively. The conductors 17 and 19 terminate at their other ends in the connector 15, whose complementary counterpart 13 enables quick connection/disconnection to the regulated source of power delivered from the rheostat/ballast 29 via conductors 41 and 43.

Although the conductors 17 and 19 are shown in FIG. 2 as exiting the base portion 7 of the adapter 12 from its side wall 88, the present invention includes the embodiment in which the conductors 17 and 19 exit the base portion at its upper surface 77.

Thus, to utilize the present invention, one provides a lamp of the prior art and screws in an adapter 12 into the lamp's socket, and subsequently inserts a fluorescent lamp into the adapter. Next, power is connected to the adapter 12, preferably by connection to connector 15 of a source of regulated power sufficient to illuminate the lamp 20. Then, the lamp is energized to provide lighting. In fact, the lamp's original power cord is not needed, and may even be cut off and discarded.

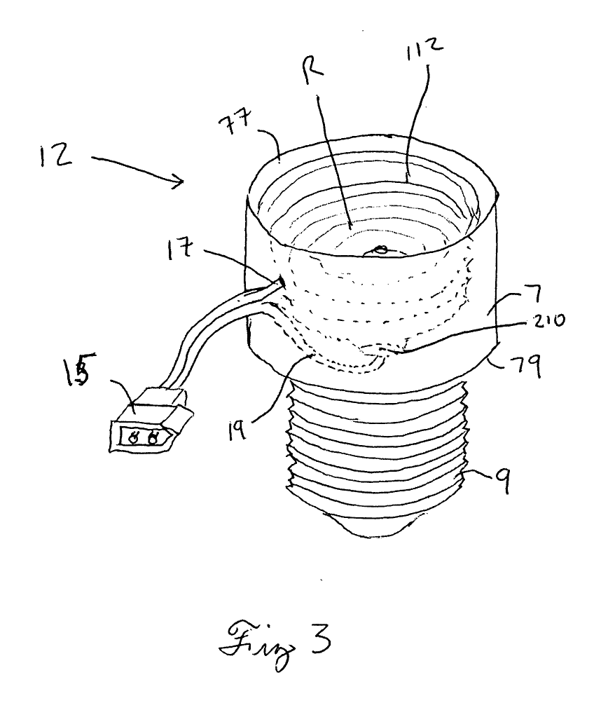

FIG. 3 shows a socket 12 according to an alternate form of the invention, in which the socket comprises a base portion 7 having a top portion 77 and an underside portion 79. There is a threaded portion 9 attached to the underside portion, and the threaded portion 9 is contoured to be screwed into a standard light bulb socket. Connector 15 has two conductors 17 and 19. In this embodiment, there is also provided a opening R, which is a hole similar to that present in a conventional lamp socket, which features female threads 112 into which a standard light bulb may be screwed. The female threads 112 are made from an electrically-conductive material, such as steel, aluminum, brass, etc. and one of the conductors, 17 is in effective electrical contact with threads 112. At the bottom of the opening R there is a conductive (metallic) bottom portion 210 to which is connected the remaining conductor 19. Under such an arrangement, a standard light bulb may be screwed into the threads 112 and may be caused to be illuminated when electrical power is supplied to the conductors 17 and 19, say, via connection to the adapter 15. This embodiment is especially useful when it is desired to utilize a compact fluorescent lamp having a built-in ballast, for all one needs to do is to screw the compact fluorescent lamp into the threads 112 and supply sufficient electrical power to conductors 17 and 19, causing the lamp to become lit. According to a preferred form of this embodiment, the threads 9 are comprised of a non-conducting material such as wood, plastic, composites, etc. so that the lamp socket into which the adapter 12 it self is screwed in does not supply electrical energy to the lamp which is screwed into the threads 112.

Fluorescent lamps are generally known to be of either the two-prong type or the four-prong type. In the two prong type, each of the prongs serve as lamp power supply contacts, that is—it is through them that electrical energy is communicated from the power source to the inside of the arc-discharge tube. Typically, such prongs are pin-shaped. In the four-prong variety, of which common 48 inch fluorescent lamps are an example, two of the prongs are used as lamp power supply contacts, while the remaining two serve as starter electrodes across which is applied a momentary high voltage pulse whose function is to ionize the gas in the tube to the extent that current may flow from one lamp power supply contact to the other. Although the invention thus far has been described as being suitable for use with a two pin fluorescent lamp, the same principles apply to the use of a four-pin lamp, by modifying the wiring in a way which would be clear to anyone of ordinary skill in this art after reading this specification and the appended claims to include a starter. The starter may be contained as part of the lamp assembly itself, or the rheostat/ballast 29 may include a fluorescent starter, where necessary, i.e., where the ballast or the lamp itself does not include a starter. There is no limit to the type of ballasts which are useful in the present invention. In fact, a variety of ballasts can be used with the same lamp, including computer-controlled ballasts which are well-known to those of ordinary skill in this art. It is easy, in accordance with the teachings herein, to change the ballast used as the conditions under which the lamp operates vary. The use of ballasts in fluorescent lighting have been known for quite some time. As an example, the Robertson Transformer Company of Rochester, Ind. supplies a wide variety of transformers and in particular their Catalog Number SP 1322 P transformer serves as an excellent and preferred ballast in accordance with this invention when used in conjunction with a 13 watt fluorescent lamp, model PL-C13W/27 available from Phillips Electronics Ltd. of Scarborough, Ontario, Canada. The ballasts suitable herein may or may not have a metallic core, such as mu-metal or other core materials well-known to those skilled in the art of ballasts useful for fluorescent lamps. The type and shape of ballast to be used is readily determinable by one of ordinary skill from considerations of the wattage rating of the lamp employed and the line voltage.

The lamp type used is preferably that of the aforementioned which is available from Phillips Electronics, Ltd. However, nearly any compact fluorescent lamp is adaptable for use in conjunction with the adapter taught herein, provided that the ballast used is matched thereto. Again, the type and shape of ballast to be used is readily determinable by one of ordinary skill from considerations of the voltage and wattage rating of the lamp employed.

Arc discharge lamps generally consist of an evacuated space such as a tubular glass envelope having a plurality of electrodes disposed within the glass envelope and which are accessible from the outside of the envelope. In principle, a potential is applied across the electrodes, and an electrical current is caused to flow through the glass envelope which results in electronic excitation of the matter disposed within the glass envelope. It is the matter disposed within the envelope which is responsible for conferring conductance to the envelope as a whole, for if the envelope were completely evacuated, no current could flow. Various media are used to render discharge tubes conductive to electrical energy with elemental mercury being by far the most common as such material is the gas by which the common fluorescent tubes observed daily are made conductive. However, other metals, gases, such as the noble gases and mixtures of these materials with one another have been used with equal success, the choice of metal or gas being dependent upon the desired light frequency and thermodynamic efficiency factors. It is usually necessary, as is well-known to those for ordinary skill in this art, to provide a momentary pulse (or trigger) of ultra high voltage to the gaseous metal atoms disposed within the envelope, in order to provide initial excitement from which the mass of gas as a whole becomes conductive. As used in this specification and the appended claims, the words “arc discharge lamp” means any lamp or discharge tube capable of producing light energy under the stimulation of an applied electrical voltage, whether or not a trigger voltage need be applied to initiate the production of light energy, and wherein the number of lumens produced per watt of energy consumed is greater than that normally encountered when using commercially available incandescent light sources which are in popular use in homes. As used herein, arc discharge lamp includes fluorescent lamps such as those commercially available under the moniker “fluorescent lamp”, High Intensity Discharge lamps, such as those which employ a metallic vapor as the conducting means, as well as those which employ noble gases, including xenon discharge tubes.

Various connectors are known in the electrical arts for providing a coupling between two devices or a device and a power supply, etc. which is readily connectable or detatchable. The automotive industry employs a wide range of such connectors on all vehicles produced. The type and configuration of the connectors employed are not critical, provided that connections of integrity result from the mating of the two connector halves.

A starter used in the combinations taught herein may be any one of several types well-known and available for use with fluorescent lighting systems. It is one of the major advantages of this invention to be able to use essentially any one of several thousands of starter/ballast/lamp combinations desired in a particular application. The field of fluorescent lamp starters is well-developed and several types are known to those of ordinary skill in this field.

The adapter 12 of the invention may be made from a single construct, such as by injection molding, or it may be comprised of two pieces, joined together using conventional fastening means.

Consideration must be given to the fact that although this invention has been described and disclosed in relation to certain preferred embodiments, obvious equivalent modifications and alterations thereof will become apparent to one of ordinary skill in this art upon reading and understanding this specification and the claims appended hereto. This includes the subject matter defined by any combination of any one of the various claims appended hereto with any one or more of the remaining claims, including the incorporation of the features and/or limitations of any dependent claim, singly or in combination with features and/or limitations of any one or more of the other dependent claims, with features and/or limitations of any one or more of the independent claims, with the remaining dependent claims in their original text being read and applied to any independent claim so modified. This also includes combination of the features and/or limitations of one or more of the independent claims with the features and/or limitations of another independent claim to arrive at a modified independent claim, with the remaining dependent claims in their original text being read and applied to any independent claim so modified. Accordingly, the presently disclosed invention is intended to cover all such modifications and alterations, and is limited only by the scope of the claims which follow, in view of the contents of this specification.

1) An adapter useful for retrofitting lamp fixtures designed for incandescent light bulbs, with an arc discharge lamp, which adapter comprises:
a) a base portion having a side wall, an upper surface, and a lower surface, which upper surface is adapted to receive an arc discharge lamp, and wherein said base portion includes a plurality of sockets which are adapted to receive the pins of an arc discharge lamp when such lamp is inserted into said base portion;
b) a threaded tip portion attached to the lower surface of said base portion which threaded tip portion has an outer surface which is contoured to screw into a conventional lamp socket; and
c) means for conveying electrical energy to said plurality of sockets, wherein the outer surface of said threaded tip portion is not essential for conveying electrical energy to any of said sockets.

2) An adapter according to claim 1 wherein said outer surface of said threaded tip portion is not part of the means for conveying electrical energy to said sockets

3) An adapter according to claim 1 wherein said means for conveying electrical energy to said plurality of sockets comprises a plurality of wires, with each wire being connected to one of said sockets.

4) An adapter according to claim 1 wherein said means for providing electrical energy to said plurality of sockets comprises a plurality of wires, each having a first end portion and a second end portion, wherein said first end portion of said plurality of wires is in effective electrical contact with a socket and wherein said second end portion of each of said plurality of wires exits said base portion of said adapter from its side.

5) An adapter according to claim 4 wherein said second end portion of each of said plurality of wires terminate in a quick-disconnect type connector.

6) An adapter according to claim 1 wherein said means for providing electrical energy to said plurality of sockets comprises a plurality of wires, each having a first end portion and a second end portion, wherein said first end portion of said plurality of wires is in effective electrical contact with a socket and wherein said second end portion of each of said plurality of wires exits said base portion of said adapter from its top surface.

7) An adapter according to claim 6 wherein said second end portion of each of said plurality of wires terminate in a quick-disconnect type connector.

8) An adapter according to claim 1 wherein said means for providing electrical energy to said plurality of sockets comprises a plurality of wires, each having a first end portion and a second end portion, wherein said first end portion of said plurality of wires is in effective electrical contact with a socket and wherein said second end portion of each of said plurality of wires terminates in a quick-disconnect type connector.

9) A system for providing illumination which comprises:
a) a conventional lamp that is designed to receive conventional incandescent lamps screwed into an on-board socket;
b) an adapter according to claim 1 screwed in said on-board socket;
c) an arc-discharge lamp affixed to said adapter; and
d) a source of electrical energy in effective electrical contact with said means for providing electrical energy to said plurality of sockets.

10) A system according to claim 9 wherein said source of electrical energy is rheostat-controlled.

11) A system according to claim 9 wherein said source of electrical energy includes at least one element selected from the group consisting of: a rheostat, a fluorescent starter, and a ballast.

12) A system according to claim 9 wherein said means for conveying electrical energy to said plurality of sockets comprises a plurality of wires, with each wire being connected to one of said sockets.

13) A system according to claim 12 wherein said plurality of wires include a quick-disconnect type connector along their lengths.

14) A system for providing illumination which comprises:
a) a conventional lamp that is designed to receive conventional incandescent lamps screwed into an on-board socket;
b) an adapter according to claim 3 screwed in said on-board socket;
c) an arc-discharge lamp affixed to said adapter; and
d) a source of electrical energy in effective electrical contact with said means for providing electrical energy to said plurality of sockets.

15) A system according to claim 14 wherein said source of electrical energy is rheostat-controlled.

16) A system according to claim 14 wherein said source of electrical energy includes at least one element selected from the group consisting of: a rheostat, a fluorescent starter, and a ballast.

17) A system according to claim 14 wherein said means for conveying electrical energy to said plurality of sockets comprises a plurality of wires, with each wire being connected to one of said sockets.

18) A system according to claim 17 wherein said plurality of wires include a quick-disconnect type connector along their lengths.

19) An adapter useful for retrofitting lamps designed for incandescent light bulbs with an arc-discharge lamp, which adapter comprises:
a) a base portion having:
i) a side wall;
ii) an upper surface; and
iii) a lower surface,
wherein said base portion includes a opening in its upper surface that comprises:
i) electrically-conductive female threads that are contoured to receive a conventional lamp having an end portion with external threads; and
ii) an electrically-conductive bottom portion, which is electrically insulated from said electrically-conductive female threads;
b) a threaded tip portion attached to the lower surface of said base portion which threaded tip portion has an outer surface which is contoured to screw into a conventional lamp socket; and
c) means for conveying electrical energy to said electrically-conductive female threads;
d) means for conveying electrical energy to said electrically-conductive bottom portion.

20) An adapter according to claim 19 wherein said outer surface of said threaded tip portion is not essential for conveying electrical energy to either of said electrically-conductive female threads and said electrically-conductive bottom portion.
